(19) United States
(12) Patent Application Publication
(10) Pub. No.: US 2012/0224790 A1
(43) Pub. Date: Sep. 6, 2012

(54) APPARATUS AND METHOD FOR CHECKING LOTTERY TICKETS

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/086,467

(22) Filed: Apr. 14, 2011

(30) Foreign Application Priority Data
Mar. 2, 2011 (TW) 100107000

(51) Int. Cl. G06K 9/22; G06K 9/20

(52) U.S. Cl. 382/313; 382/312

(57) ABSTRACT

An apparatus for checking lottery tickets includes a camera and a processing unit. The camera captures an image of a lottery ticket. The processing unit is connected to the camera to receive the image of the lottery ticket and captures a set of numbers in the image. The processing further reads a set of winning numbers and a winning rule of the lottery according to a type and an issue number, and compares the set of numbers on the image with the set of winning numbers according to the winning rule to determine whether the lottery ticket wins a prize or/and which prize the lottery ticket wins.

### BACKGROUND

1. Technical Field

The present disclosure relates to a system and a method for checking lottery tickets.

2. Description of Related Art

When a user needs to determine whether a lottery ticket wins a prize, the user must first look up a set of winning numbers. Then the user compares his or her set of numbers on the lottery ticket with the set of winning numbers to determine whether his or her lottery ticket wins a prize. This is an inconvenience.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an exemplary embodiment of an apparatus for checking lottery tickets.

FIGS. 2-5 are schematic diagrams of the apparatus of FIG. 1 in a state of use.

FIG. 6 is a flowchart of an exemplary embodiment of a method for checking lottery tickets.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

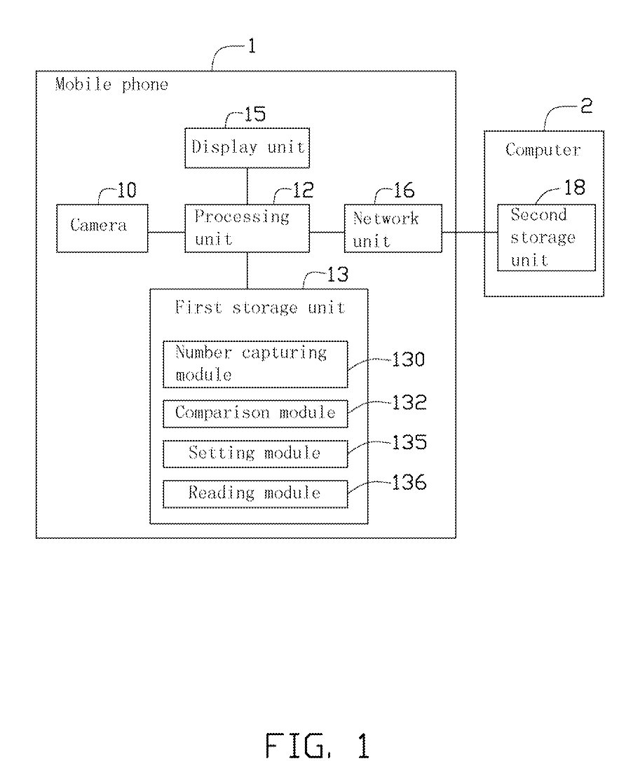

Referring to FIG. 1, an exemplary embodiment of an apparatus for checking lottery tickets includes a camera 10, a processing unit 12, a first storage unit 13, a display unit 15, a network unit 16, and a second storage unit 18. In the embodiment, the camera 10, the processing unit 12, the first storage unit 13, the display unit 15, and the network unit 16 are set in a hand held apparatus, such as a mobile phone 1. The second storage unit 18 is set in a computer 2. The mobile phone 1 communicates with the computer 2 with the network unit 16. The camera 10, the first storage unit 13, the display unit 15, and the network unit 16 are all connected to the processing unit 12.

The first storage unit 13 includes a number capturing module 130, a comparison module 132, a setting module 135, and a reading module 136, which may include one or more computerized instructions to be executed by the processing unit 12.

The camera 10 captures an image of a lottery ticket. The number capturing module 130 is used to obtain a plurality of numbers from the image obtained by the camera 10. It can be understood that the number capturing module 130 uses well known technology to obtain the numbers in the image. The setting module 135 is used to select a type and an issue number of a lottery ticket. The second storage unit 18 stores a plurality of sets of winning numbers and winning rules. Each set of winning numbers corresponds to one type of lottery and one issue number of the lottery ticket. Each winning rule corresponds to one type of lottery. The reading module 136 reads a set of winning numbers and a winning rule from the second storage unit 18 according to the type and the issue number selected by the setting module 135.

The comparison module 132 is used to compare the set of winning numbers with the captured numbers from the number comparison module 130 according to the winning rule of the lottery. For example, according to the rule, if all of the captured numbers are the same as the set of winning numbers, the lottery ticket wins the first prize. If five of the captured numbers are the same as five of the set of winning numbers, the lottery ticket wins the second prize. The display unit 15 is used to display a comparison result from the comparison module 132.

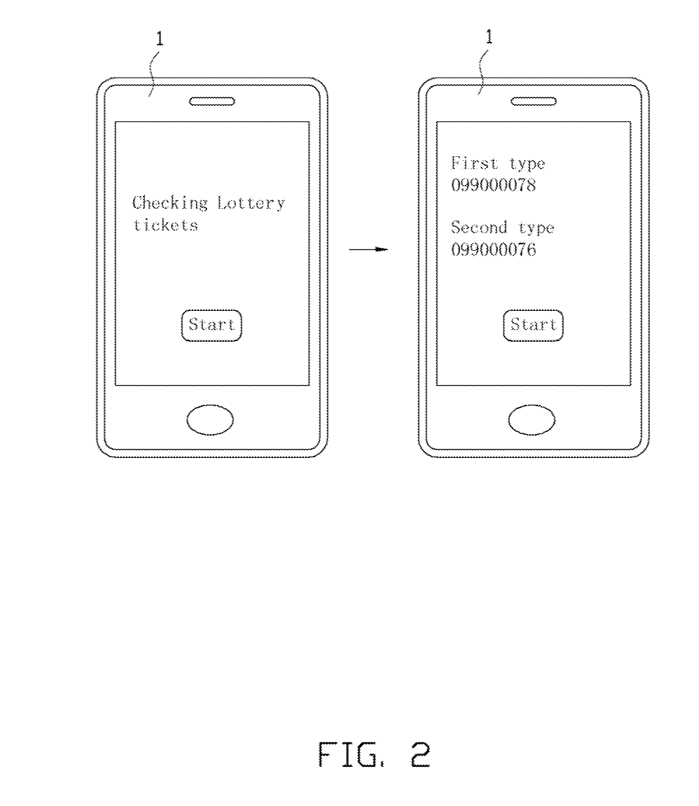

Referring to FIG. 2, in use, a user selects a first type and an issue number of “099000078” with the setting module 135. The reading module 136 reads a set of winning numbers and a winning rule from the second storage unit 18 according to the first type and the issue number. In this embodiment, the set of winning numbers is “01 34 55 67”.

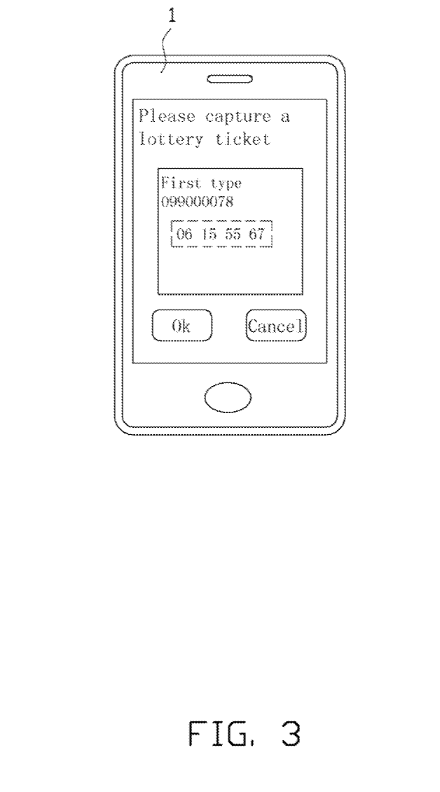

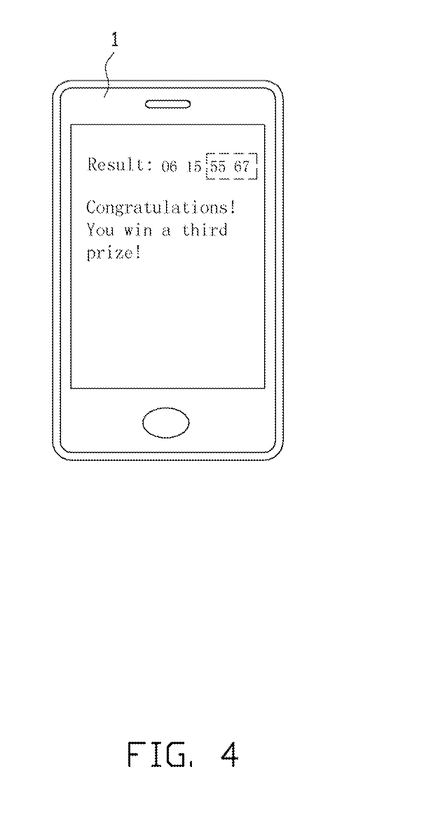

Referring to FIG. 3, the user captures an image of a lottery ticket with the camera 10. The captured image of the lottery ticket is transmitted to the number capturing module 130. The number capturing module 130 obtains a set of numbers from the image. In this embodiment, the set of numbers is “06 15 55 67”. The comparison module 132 compares the set of numbers of “06 15 55 67” captured with the set of winning numbers of “01 34 55 67” to obtain that there are four numbers in the set of numbers captured same with the set of winning numbers. According to the winning rule, the lottery ticket wins a third prize. The display unit 15 displays the result (shown in FIG. 4).

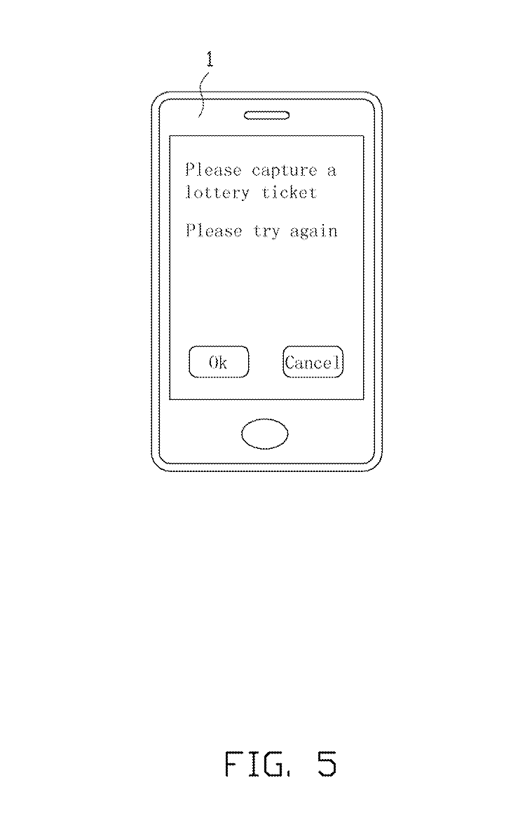

Referring to FIG. 5, if the number capturing module 130 does not discern numbers in the image, the processing unit 12 determines that the image is not an image of a lottery ticket. Moreover, if a group of digits of the set of numbers in the image is different from the group of digits of the set of numbers of the winning numbers, the processing unit 12 determines that the image is not an image of a lottery ticket. At this time, the display unit 15 warns the user to capture the image again.

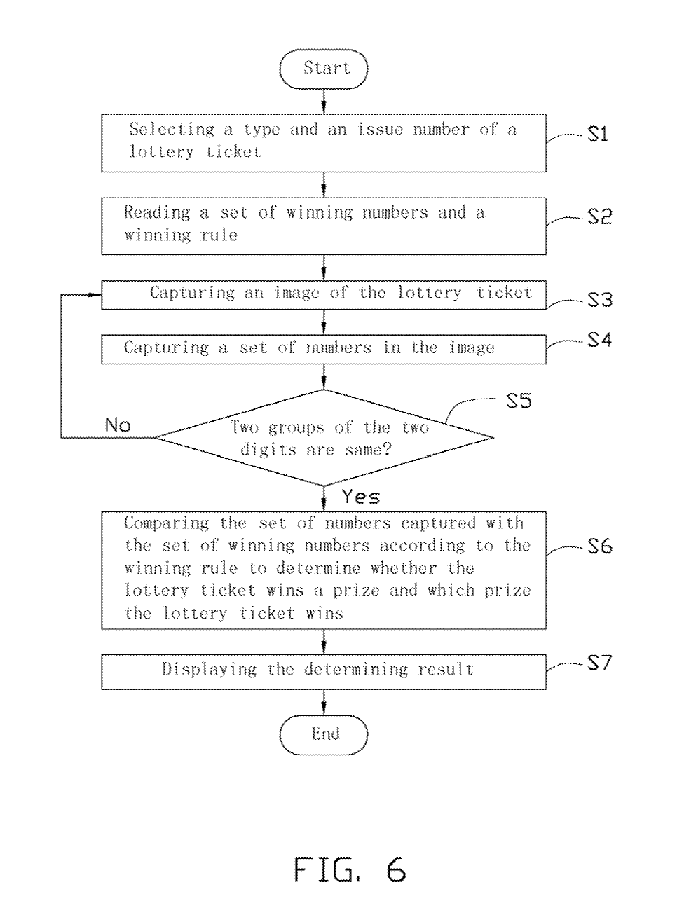

Referring to FIG. 6, an exemplary embodiment of a method for checking lottery tickets includes the following steps.

In step S1, the setting module 135 selects a type and an issue number of a lottery ticket.

In step S2, the reading module 136 reads a set of winning numbers and a winning rule from the second storage unit 18 according to the type and the issue number of the lottery ticket.

In step S3, the camera 10 captures an image of the lottery ticket.

In step S4, the number capturing module 130 captures a set of numbers in the image.

In step S5, the comparison module 132 compares a group of digits of the set of numbers in the image with the group of digits of the set of winning numbers. If the group of digits of the set of the numbers in the image is the same as the group of digits of the set of winning numbers, it flows to step S6. If the group of digits of the set of the numbers in the image is different from the group of digits of the set of winning numbers, it flows to step S3. The camera 10 captures the lottery ticket again.

In step S6, the comparison module 132 compares the set of numbers captured with the set of winning numbers according to the winning rule to determine whether the lottery ticket wins a prize and which prize the lottery ticket wins.

In step S7, the display unit 15 displays the determining result.

The foregoing description of the exemplary embodiments of the disclosure has been presented only for the purposes of illustration and description and is not intended to be exhaustive or to limit the disclosure to the precise forms disclosed. Many modifications and variations are possible in light of everything above. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An apparatus for checking lottery tickets, the apparatus comprising:
a camera to capture an image of a lottery ticket;
a processing unit connected to the camera to receive the image of the lottery ticket;
a first storage unit connected to the first processing unit and storing a plurality of programs to be executed by the first processing unit, wherein the first storage unit comprises:
a number capturing module to capture a set of numbers in the image captured by the camera;
a setting module to select a type and an issue number of the lottery ticket;
a reading module; and
a comparison module; and
a second storage unit to store a plurality of set of winning numbers and a plurality of winning rules, wherein the reading module reads a set of winning numbers and a winning rule of the lottery ticket according to the type and the issue number from the second storage unit, the comparison module compares the set of numbers with the set of winning numbers according to the winning rule to determine whether the lottery ticket wins a prize or/and which prize the lottery ticket wins.

2. The apparatus of claim 1, further comprising a display unit connected to the processing unit, wherein the display unit displays the comparison result.

3. The apparatus of claim 2, further comprising a network unit connected to the processing unit, wherein the camera, the processing unit, the first storage unit, the network unit, and the display unit are set in a hand held apparatus, the processing unit communicates with the second storage unit with the network unit.

4. The apparatus of claim 1, wherein the comparison module further compares a group of digits of the set of numbers in the image with a group of digits of the set of winning numbers, if the two group of digits are different, the camera captures an image of the lottery ticket again.

5. A method for checking lottery tickets, the method comprising:
selecting a type and an issue number of a lottery ticket;
reading a set of winning numbers and a winning rule according to the type and the issue number;
capturing an image of the lottery ticket;
obtaining a set of numbers in the image captured; and
comparing the set of numbers with the set of winning numbers according to the winning rule to determine whether the lottery ticket wins a prize or/and which prize the lottery ticket wins.

6. The method of claim 5, wherein between the steps “obtaining a set of numbers in the image captured” and “comparing the set of numbers with the set of winning numbers according to the winning rule to determine whether the lottery ticket wins a prize or/and which prize the lottery ticket wins” comprises:
comparing a group of digits of the set of numbers in the image with a group of digits of the set of numbers of the winning numbers;
if the two groups of digits are the same, the method flows to the step “comparing the set of numbers with the set of winning numbers according to the winning rule to determine whether the lottery ticket wins a prize or/and which prize the lottery ticket wins”, and
if the two groups of digits are different, it returns to the step “capturing an image of the lottery ticket”.

7. The method of claim 5, further comprising:
displaying the comparison result on a display unit.
